(19) United States
(12) Patent Application Publication
(10) Pub. No.: US 2008/0184026 A1
(43) Pub. Date: Jul. 31, 2008

(54) Metered Personal Computer Lifecycle

(76) Inventors: Martin H. Hall, Sammamish, WA (US); Zhangwei Xu, Redmond, WA (US); Jeffrey Alan Herold, Bellevue, WA (US); Curt Andrew Steeb, Redmond, WA (US); Rajagopal Venkatachalam, Redmond, WA (US); Douglas Reed Beck, Seattle, WA (US); David James Foster, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(21) Appl. No.: 11/668,442

(22) Filed: Jan. 29, 2007

(51) Int. Cl. G06F 9/00

(52) U.S. Cl. 713/100

(57) ABSTRACT

A metered-use computer is operable in a number of states or modes to accommodate manufacture, test, operation and end-of-life. During manufacturing, a security module may be set to a non-metered mode, where no measurements are taken. At the end of the manufacturing process, the security module may be set to an active mode where metering and measurement of the computer are enforced. When terms of a purchase contract or other user agreement are satisfied, the computer may be set to a non-enforcement state where all metering and metering-related security are disabled. A one-time reset of the active mode is supported to allow end-of-line quality assurance testing.

### BACKGROUND OF THE INVENTION

Pay-as-you-go or pay-per-use business models may be applied to high value products, such as computers. The cellular telephone industry has for years subsidized sales of handsets in exchange for multi-month subscription commitments. However, cellular telephones are virtually useless when not connected to a network. The use of a subsidized-sale business model becomes more complicated when selling an electronic device, such as a computer, with significant value as standalone unit when not connected to a network. Such an electronic device may even have enough scrap value to encourage fraudulent purchase for the purpose of stripping the electronic device to its component parts.

Security measures may be taken to allow the electronic device to police itself to enforce compliance to service contract commitments. Such measures may include tying components, peripherals, or both to the electronic device to discourage salvage. However, the added security measures associated with contract enforcement may cause difficulties during the manufacturing and post-manufacturing test or quality assurance checks. Because contract compliance security may include enforcement of subscription terms, and such subscription relationships have not been made during manufacturing, the compliance-related security may enforce sanctions that could include system resets and peripheral disabling.

### SUMMARY

An electronic device constructed for use in a pay-per-use or subscription business model may be set to any of a number of operating states to accommodate various stages in the product lifecycle. For example, during manufacturing, a non-metered state may be set that allows the computer to operate without having any subscription terms active. Metering and enforcement may be suspended, but certain validation activities may be maintained to allow creation of an audit trail through the manufacturing process.

An active state may be used to enforce contract terms. The active state may require proof of compliance to contract terms, such as a store of pre-paid usage time or a paid up subscription. If the contract terms are violated, the electronic device may take enforcement measures including a limited operation mode that only activates enough resources to present a user interface for bringing the electronic device back into compliance.

In addition to manufacturing and active states, a pay-per-use business model may include an end-of-term incentive that allows an end-user to take ownership of the electronic device upon successful completion of the contract. A third operating state may allow all metering and enforcement to be disabled, even permanently disabled, so that the end-user can use or modify the electronic device at will after completing the obligations under the subsidized purchase contract.

### BRIEF DESCRIPTION OF THE DRAWINGS

FIG. 1 is a block diagram of a logical view of a computer;

FIG. 2 is a block diagram of a security module that may be incorporated into the computer of FIG. 1;

FIG. 3 is a state diagram showing exemplary operating states in a pay-per-use computer; and

FIG. 4 is flow chart depicting an exemplary method of managing state transitions in pay-per-use computer.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the clams), To the extent that any term recited hi the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

In order to support the lifecycle of a computer or other pay-per-use electronic device, the implementation of various operating states may be useful. For example, during manufacturing, the security and metering operations inherent in normal use may prohibit assembly and test operations. Conversely, one business model may implement an end of life policy similar to other rent-to-own models. That is, ownership of an essentially leased computer transfers to a subscriber upon successful completion of the lease term. At that point, it may be desirable to have security and metering operations disabled or suspended indefinitely, allowing the subscriber to make changes and modifications as desired.

The following description first illustrates a representative computer, then a representative security module used to implement paper use operation and then discusses implementation of a state machine supporting various lifecycle states, or modes, and their operation and transitions between those various lifecycle states.

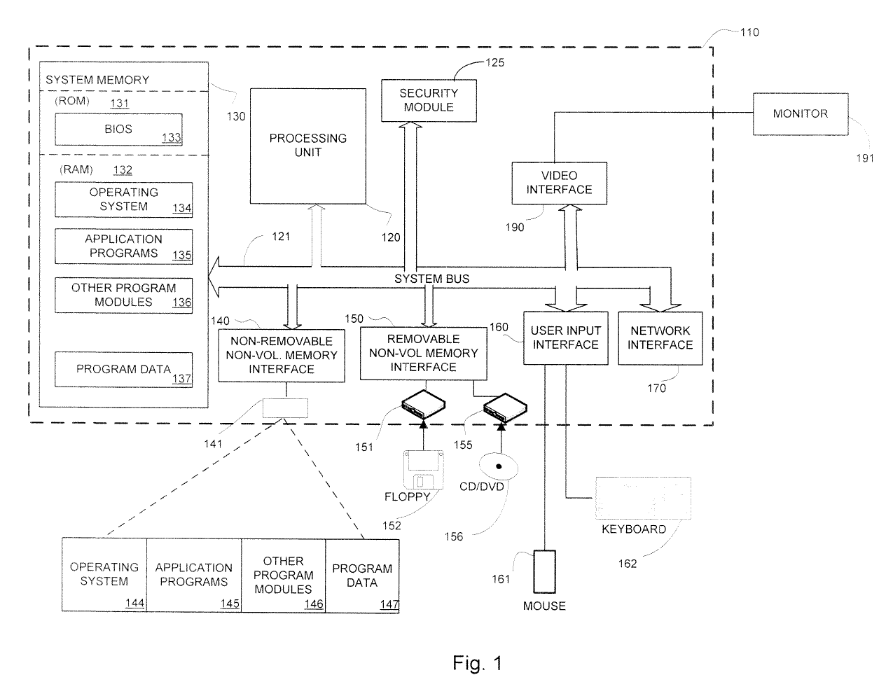

FIG. 1 illustrates a logical view of a computing device in the form of a computer 110 that may be used in a pay-per-use or subscription mode. For the sake of illustration, the computer 110 is used to illustrate the principles of the instant disclosure. However, such principles apply equally to other electronic devices, including, but not limited to, cellular telephones, personal digital assistants, media players, appliances, gaming systems, entertainment systems, set top boxes and automotive dashboard electronics, to name a few. Components of the computer 110 may include, but are not limited to a processing unit 120, a system memory 130, and a system bus 121 that couples various system components including the system memory to the processing unit 120. The system bus 121 may be any of several local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, front side bus, and Hypertransport™ bus, a variable width bus using a packet data protocol.

The computer 110 may include a security module 125 (SM). The SM 125 may be enabled to perform security monitoring, pay-per-use and subscription usage management, and policy enforcement related to terms and conditions associated with paid use, particularly in a subsidized purchase business model. The security module 125 may be embodied in the processing unit 120, as a standalone component, a hybrid, or multi-chip module (MCM), as examples.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110.

The system memory 130 includes computer storage media in the form of volatile and/or nonvolatile memory such as read only memory (ROM) 131 and random access memory (RAM) 1332. A basic input/output system 133 (BIOS), containing the basic routines that help to transfer information between elements within computer 10, such as during, start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media a magnetic disk drive 151 that reads from or writes to a removable, nonvolatile magnetic disk 152, and an optical disk drive 155 that reads from or writes to a removable, nonvolatile optical disk 156 such as a CD ROM, DVD, or other optical media. Other removable/non-removable, volatile/nonvolatile computer storage media that can be used in the exemplary operating environment include, but are not limited to, magnetic tape cassettes, flash memory cards, digital video tape, solid state RAM, solid state ROM, phase change memory, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, digital camera, or the like. These and other input devices are often connected to the processing unit 121 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190.

The computer 110 may operate in a networked environment using logical connections to one or more remote computers (not depicted) over a network interface 170, such as broadband Ethernet connection or other known network.

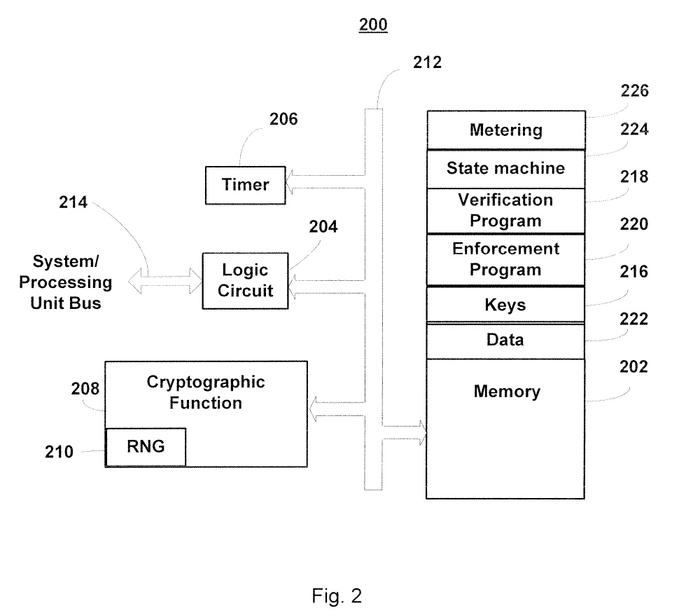

FIG. 2 is a simplified and representative block diagram of a security module 200, the same as, or similar to, the security module 125 of FIG. 1. Referring to FIG. 2, a simplified and representative security module is discussed and described. The security module may be similar to the security module 125 introduced above. The security module 200 may include a memory 202, a logic circuit 204, and a clock or timer 206, for example, the timer 206 may be used to implement a clock by counting intervals of real time. The memory 202 may include both volatile and non-volatile memory.

The security module 200 may further include a cryptographic function 208. A random number generator 210 may be a part of the cryptographic function 208. Digital signature technology is well known and hashing, signature verification, symmetric and asymmetric algorithms and their respective keys are not discussed here in detail. The cryptographic function may be implemented in hardware, for example, using a smart chip, or may be implemented in software.

The blocks of the security module 200 may be coupled by a bus 212. The bus 212 may be separate from a system or processing unit bus 214 used for external access. Separate busses may improve security by limiting access to data passed by bus 212. The bus 212 may incorporate security precautions such as balanced data lines to make power attacks on cryptographic keys 216 stored in the memory 202 more difficult.

The memory 202, may include non-volatile memory that, in addition to storing cryptographic keys 216, may store at least one verification program 218, at least one enforcement program 220, and at least one metering program 226. These programs are discussed in more detail below. Other data 222 may be stored in the memory 202, for example, hash codes and/or other digital signature information associated with known BIOS code or application programs. Other examples of data 222 that may be stored in memory 202 may be compliance data pertaining to the current state of the computer 110 or certificate information for verification of downloaded updates to verification programs 218 or enforcement programs 220. State machine data may be used to implement a state machine in the logic circuit 204 or externally, by the system processor 120. The state machine 224 may allow definition of different sets of enforcement and verification rules depending on the state. Included in the data 222 may be BIOS information that may also allow a trusted, secure, boot process prior to activation of the operating system 144 of FIG. 1A.

The validation and enforcement programs 218 220 are shown stored in the security module 200, but may also be stored externally, with a digital signature or hash of the programs stored in the security module 200, for example, in the data section 216 of the memory 202. When monitoring or measuring an application program, the security module 200 may validate a hash or digital signature of the application program before or during the program's execution. Since the programs 218 220 and data stored in memory 202 are part of the security associated with the success of the pay-as-you-go, pay-per-use business model, it may be important that the data be protected from unauthorized access and tampering. Unauthorized access of the memory 202 may be limited using either the logic circuit 204 or the cryptographic function 208 or a combination of the two. The access to the memory may be restricted to processes running a known program code, i.e. a program code trusted by the security module 200. The program code may be the validation program 218, the enforcement program 220, or the state machine 224. However, other programs may be granted access to the memory 202. For example, an application supporting the management of usage credits or balances may use the memory of the security module 200. When repair or maintenance is required, access to the memory 202 may be granted to a service process supported on a networked device having proper credentials in order to effect the repair.

The security module 200 may have several functions. One function of the security module 200 may be to protect itself from unauthorized updates and tampering. Programs and data stored in the security module 200 may be injected at the time of manufacture or may be downloaded if correctly signed with the signature authenticated by the security module 200 itself. Another function may be to monitor and/or measure the state of the computer 110 to determine if a hack or other unauthorized change in the state of the computer 110 is in process or has occurred. Another aspect of monitoring and measuring may be to support legitimate changes of state of the computer 110 related to functions associated with provisioning resources and hosting secure functions such as an event dispatcher or a metering function. A third function may be to validate current BIOS code and validate updates and extensions to BIOS code. Another function of the security module 200 may be to provide a reliable clock or timer both as a source of time for metering programs and expiration dates. The clock or timer may also ensure that the security module 200 is routinely granted access to the computer 110 and not “starved” for CPU cycles. Another function may be to enforce sanctions when the computer 110 is determined to be at a low limit of usage value (subscription or pre-pay) or evidence of tampering has been detected.

To protect from unauthorized updates and tampering the memory 202 may be secured. To accomplish this, the memory 202 may be made accessible only to a specific program, for example, an update routine authenticated by a digital signature under the control of a secure operating mode of the computer 110.

The security module 200 may be able to access memory used by the operating system for monitoring and sanctioning the operating system 144. The security module 200 may serve to host functions related to provisioning and activating licensed or pay-per-use resources. The security module 200 may also host a metering function that maintains an accounting of pay-per-use resources used and available.

The verification program 218 may monitor or measure a state of the computer 110. The state of the computer 110 may be used to determine the level of compliance of the computer 110 with a set of policies or pre-determined conditions. The pre-determined conditions may be both positive and negative, that is, the policy or condition may require the presence of certain elements, be they hardware, software, peripherals, etc. or the policy may prohibit the presence of certain other elements. For example, one policy may require the presence of a given version of a system driver, while another policy may prohibit the presence of an alternative boot device. To determine compliance, the verification program 218 may monitor the condition of a resource used by the operating system, the condition of an application program, the condition of a BIOS structure or a BIOS extension, or a hardware configuration of the computer. In addition, the verification program 218 may monitor compliance with various policies, for example, usage policies, including usage policies related to contractual terms of a pay-per-use contract. In the event of non-compliance, the verification program 218 may warn the user, for example, using a pop-up message, or may activate the enforcement program 220 to begin sanctions.

The metering function 226 may support the pay-per-use contractual terms by way of monitoring use of the computer 110 and either subtracting time from a usage balance or simply verifying a subscription period. The metering function 226 may both determine when the computer is in active use and should be metered versus system-only activities that should not be metered.

The timer 203 may operate in conjunction with the metering function 226 and provide a reliable measure for pay-per-use terms involving periods of time, for example, unlimited use for a month. The timer 206 may also act as a trigger to ensure that the verification and/or enforcement programs 218 220 of the security module 200 receive enough processor execution cycles to perform their respective tasks. The trigger function may cause the logic circuit 204 to force execution of the verification program 218. The logic circuit 204 may force an interrupt that causes the processing unit 120 to execute the verification program 218 from the appropriate location.

The enforcement program may be called when the verification program 218 determines non-compliance and a corrective action may be instituted. For example, the enforcement program 220 may cause a non-compliant driver to be overwritten with a driver from a known location. Conversely, when the non-compliant condition is not automatically correctable, a sanction may be imposed to encourage the user to bring the system into compliance. Sanctions may be invoked by the logic circuit 204 activating the enforcement program 220. To carry out the enforcement task, the security module 200, under the direction of the enforcement program, may disable or otherwise sanction resources under the direct influence or control of the computer 110. The policy may vary according to the state of the computer and may include reducing the processing speed of the computer or reducing the functional operation of the computer, such as booting in “safe mode.” Other sanctions may include limiting the amount of random access memory available for processing, limiting the Instruction Set Architecture, i.e. the processor commands available for execution, slowing access to a hard disk 141 or limiting the space accessible on the hard disk drive 141. Additional sanctions may include limiting the display resolution or even causing frequent, periodic resets of the computer 110. The goal of sanctions is that they be recoverable, and more specifically, be recoverable by the user. However, certain policies may exist that call for disabling the computer 110 to the point that qualified service personnel with special equipment are required to restore service. This may be the case when it is determined that repeated hostile attacks have been attempted over a period of time, despite warnings.

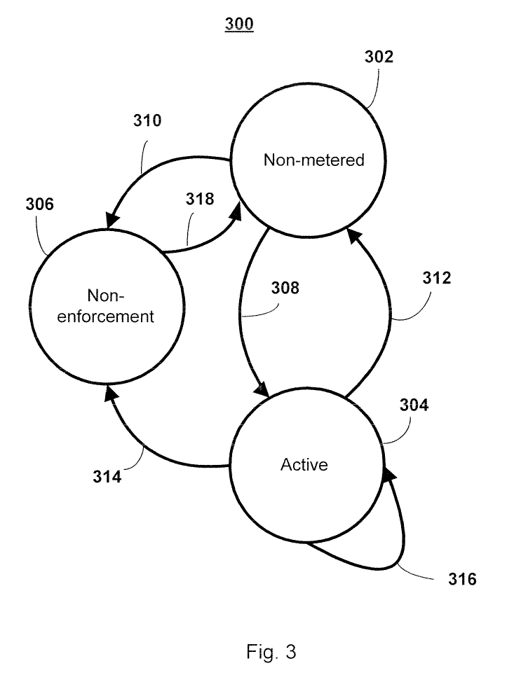

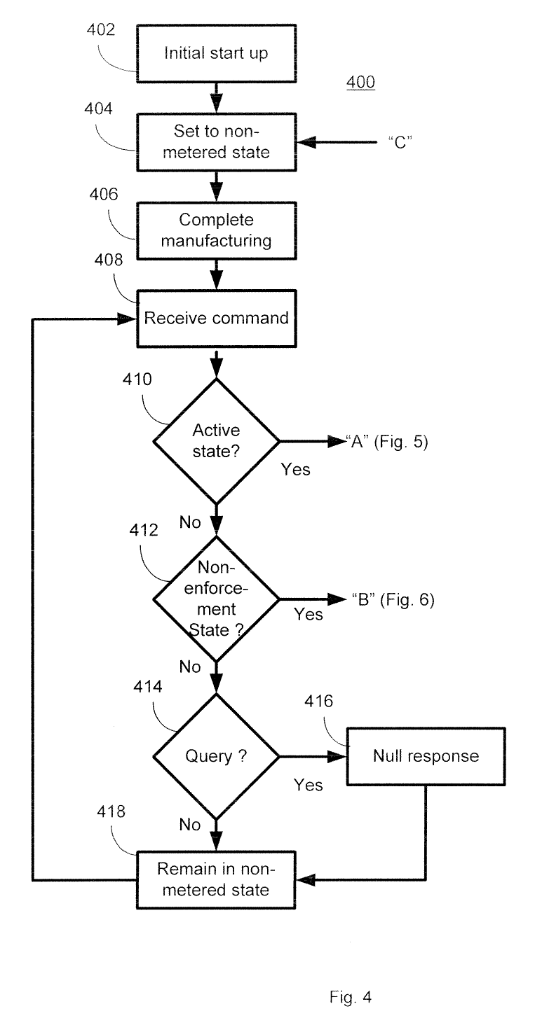

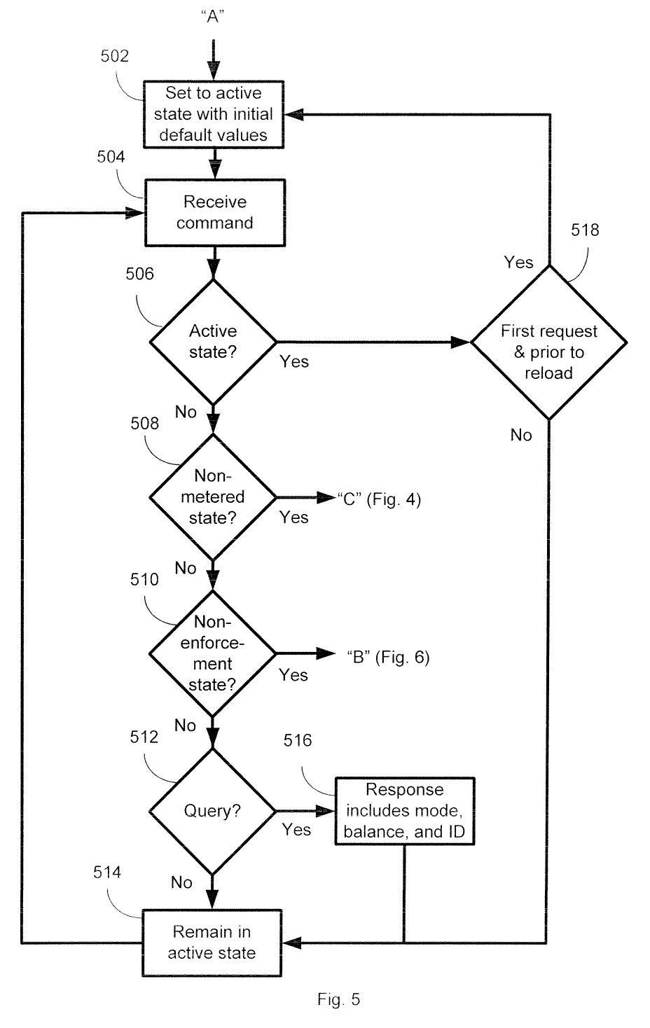

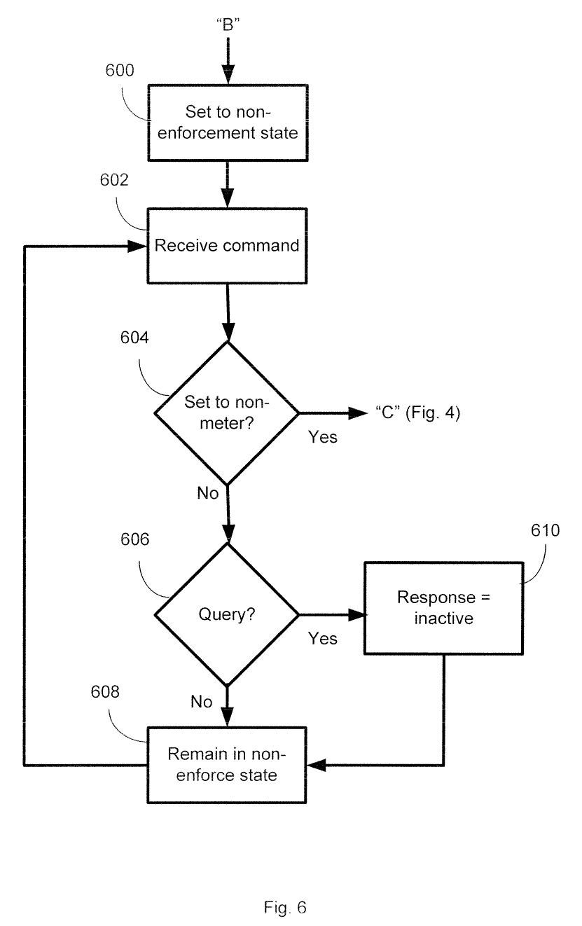

However, the active enforcement of usage policies and compliance measurements may not be possible or desirable during manufacturing, testing, or refurbishment. Further, the opportunity to own the computer without metering or verification may be a positive sales incentive for the purchaser. Therefore, different states of operation that are tied to sets of rules with differing levels of verification and enforcement may be useful. An exemplary set of these operating states and transitions between then are discussed with respect to FIG. 3 and FIG. 4.

FIG. 3 is a state diagram 300 showing three exemplary states of operation. A non-metered state 302 may be used during manufacturing and test. An active state 304 may be used during metered operation, supporting both a normal mode of operation and a restricted-use mode of operation. An exemplary embodiment may also employ a non-enforcement state 306 for use in disabling verification and enforcement, as at the end of a contract term. Transitions between each state of operation are depicted by arrows. Each transition after leaving the secure, trusted manufacturing environment occurs in response to an authenticated message instructing the security module 200 to effect the change in state, and to instantiate the appropriate set of metering, verification, and enforcement rules. Each transition may take effect upon rebooting after accepting the authenticated message. The security module 200 may enforce a reboot after accepting the authenticated message.

In the non-metered state 302, for example, during manufacturing, the security module 200 may turn off metering, since there may not be any balance in the metering function 226 or associated balance manager (not depicted). While in the non-metered state 302, the enforcement program 220 may also be turned off because measures taken to limit computer function or reload non-compliant drivers may directly impact manufacturing or test processes. However, the verification program 218 may remain active in some embodiments, even if in a reduced state. A log of verification data may be kept as a record of manufacturing steps. For example, hashes of test drivers, reboots, and software version numbers may be stored and used to indicate if unexpected and possibly malicious code versions may have been loaded during the manufacturing phase. A query of the security module 200 during the non-metered state 302 may return a null response.

The verification program 218, in this phase, may also require a signed “ping” from a known host or service after a given number of hours in the non-metered state 302. Other embodiments may allow unlimited time/usage in the non-metered state 302. The time period may be set equal to an expected manufacturing duration with some margin. Should the security module 200 remain in the non-metered state past that period, for example, a week, the verification module may place the computer in the active state 304 with a zero balance, forcing the next action to be communication with a provisioning service. This may help prevent limit the value of hacks that place the computer in the non-metered state 302 in an attempt to circumvent metering.

When the manufacturing-related operations have been completed, a message to transition to the active state 304 may cause transition 308. The transition 308 to the active state may involve starting the metering 226 and enforcement 220 programs and modifying the verification program operation to coincide with the needs of the active state 304. Another valid transition from the non-metered state 302 may be to the non-enforcement state 306 following transition 310. Transition 310 may be activated when a newly manufactured, or re-manufactured, computer is sold outright and a contract period is not required to repay subsidized value of a less-than-market price original purchase. Because transitions 308 and 310 occur in a trusted environment, e.g. manufacturing, they may activated without authentication. In most embodiments, all other transactions require authentication, which may be bound to an individual device by hardware identifier (HWID).

Transition 308 may involve setting a locale for operation, an initial usage balance, a service provider or reseller code, and one or more program codes. For example, while in one embodiment the entire package may be provided by a single service provider or reseller, in another embodiment the hardware and operating system may be offered through a first service provider with games or application programs offered through a second service provider. Each relationship may be defined by a Underwriter Program Identifier (UPID). The UPID may be a combination partner code for the company selling or manufacturing the computer, program code for the product or service being supplied, and other values used to uniquely distinguish the product or service for that class of device.

When in the active state 304, metering, value-add operations, verification, and enforcement may all operate as required by the business rules governing the contract period. When prepaid time or a subscription period expire, the user may be required to recharge the account before additional usage is authorized. The security module 200 may also enforce sanctions if tampering is detected that may be associated with attempts to defeat metering. Additional compliance-oriented security devices (not depicted) may be present in the computer, including, but not limited to, units that lock peripheral devices to a particular hardware identifier or additional security modules in communication with security module 200. A query of the security module 200 during the active state may return a subscription end date or prepaid value, the current state (active), and the one or more UPIDS.

There may be several exit points from the active state 304. For example, transition 312 may be followed back to the non-metered state 302. Transition 312 may be used when the computer 110 is to be remanufactured, for example, for upgrade, or to refurbish after being returned during a contract period. A second transition from the active state 304 may follow transition 314 to the non-enforcement state 306. The transition 314 to the non-minimum amount of usage time was purchased or subscriptions paid throughout a contract period. A third transition from the active state may use transition 316 for a single, special purpose. In the course of manufacturing operations, it is common for a statistical sample of completed units to be given a quality assurance test or other post-manufacturing test. Performing a quality assurance test will necessarily consume some of the preloaded value and may set flags associated with verification events. In order to allow each machine to leave the factory or distribution point in the same condition, transition 316 may be followed to reset the computer 110 from the active state 304 to a restored active state 304 having initial conditions fully reset. In order to discourage abuse of this capability, transition 316 may only be performed once for each time the computer 110 is in state 304, and, in one embodiment, must be performed prior to any add-value or configuration transactions, such as may be performed by a user.

When in the non-enforcement state 306 all metering, verification, and enforcement may be disabled. The security module 200 may be capable of updating its software, for example, to correct a defect associated with operation of the non-enforcement state 306 itself. In response to a query, the security module 200 may return the value inactive. In one embodiment, once the computer is placed in the non-enforcement mode 306 no further transitions are allowed and the computer will remain in the non-enforcement mode 306 for the duration of its service life. In another embodiment, transition 318 to the non-metered state 302 may be supported to allow a so-called paid-up computer to be traded in and remanufactured.

FIGS. 4-6 illustrate an exemplary method of managing the lifecycle of a pay-per-use electronic device having a plurality of states of operation. While the principles described apply to a wide range of electronic devices, the following discussion will be limited to computer 110 of FIG. 1. When computer 110 and the associated security module 125 are initially started at block 402, the computer 110 may be set to a non-metered state at block 404. The technology to set the nom-metered state is known and may include a register value set at chip-level testing, a fusable link, a write-once memory bit, or similar non-volatile flag. During the initial non-metered operation, or secondary non-metered state as described below, manufacturing processes may perform a variety of steps to assemble, package, and test the computer 110. In some embodiments, manufacturing and test may include binding certain high-value components to the computer 110, or more specifically, to the security module 125, The binding operation may involve tying components, such as a hard disk 141 or a peripheral such as monitor 191 to the computer 110 to reduce the value of component salvaging. At block 406, manufacturing may be completed and the computer 110 may be operable to receive a command at block 408 and to change its operating state. While in the non-metered state, as discussed above, metering may not be performed but other security related tasks may at least be active to create an audit trail. When a command at block 408 has been received it may be processed by the equivalent of a case statement to determine if a valid command has been received and if so, which one. At block 410, the command may be evaluated to determine if it corresponds to setting the computer 110 to an active state. If the command is valid, that is, the command can be cryptographically verified as coming from a valid source, and is an active-state command, the ‘yes’ branch from block 410 may be followed to point “A” on FIG. 5. While different business models may dictate different implementations, for example, due to more or fewer layers of distribution channel, in many cases, transition from the non-metered state to the active state may be performed prior to delivery to a user. In one embodiment, transition to the active state from the non-metered state may be the last manufacturing step performed before the computer 110 leaves the manufacturing floor. In some and exemplary embodiments, the computer 110 may remain in a secure site until the transition to the active state has been performed.

If, at block 410, the command is not an active-state command, it may be checked at block 412 to determine if it is a non-enforcement state command. If true and valid, the ‘yes’ branch from block 412 may be followed to point “B” at FIG. 6. If not true or not valid, the ‘no’ branch from block 412 may be followed to block 414 and a determination may be made if the command is a valid query command. If true, the ‘yes’ branch from block 414 may be followed to block 416 and a null response may be provided to the requesting party. If, at block 414, the command is not a valid query command, the ‘no’ branch from block 414 may be followed to block 418 and the computer 10 may be kept in the non-metered state and processing may return to block 408, waiting to receive another command. After the full response at block 416 as provided, processing nay also continue at block 418.

Turning to FIG. 5, execution may begin at point “A” and at block 502, the active state may be set. Operation of the computer 110 may proceed in the active state with metering, verification, and enforcement activities performed as described above. At block 504, a command may be received, and similar to the description of FIG. 4, the command may be evaluated for validity and content. If, at block 506, a valid active-state command has not been received, processing may follow the ‘no’ branch to block 508. If, at block 508, valid non-metered state command is received processing may follow the “yes” branch to point “C” of FIG. 4. If, at block 508, the command is not a valid non-metered state command, processing may follow the ‘no’ branch to block 510. If, at block 510 the command is a valid non-enforcement state command, the ‘yes’ branch from block 510 may be followed to point B. of FIG. 6. If, at block 510, the command is not a valid non-enforcement state command, the ‘no’ branch from block 510 may be followed to block 512. If, at block 512, the request is not a valid query command processing may continue at block 514, the computer 110 remains in the active state with normal metering, verification, and enforcement and is ready to accept a new command. If, at block 512, the command is a valid query command, processing may follow the ‘yes’ branch to block 516. At block 516, a response may be returned to the calling party with information that may include the mode, balance or subscription status, and identification information including one or more UPIDs.

Returning to block 506, if a valid active state command has been received, the ‘yes’ branch from block 506 may be taken to block 518. At block 518 it may be determined if the request to reset the active state is valid by determining if this is the first request to return to the active state and if the request is being made prior to a first value-add transaction. If both of these conditions are true, the ‘yes’ branch from block 518 may be taken to block 502 and the active state may be reset with its initial default values and processing continue at block 504. As discussed above, this activity may take place when the computer 10 has been subjected to a post manufacturing test, such as a quality assurance test. If, at block 518, the conditions for a reset of the active state have not been met, that is, the active state has been reset previously or a value add transaction has been performed, the ‘no’ branch from block 518 may be taken to block 514 or the computer remains in its current state and at block 504 waits for a next command to be received.

Point “B” may be the entry point for FIG. 6 and may be reached from corresponding points on either FIG. 4 or FIG. 5. At block 600, operation may be set to the non-enforcement state 306. When in the a non-enforcement state, no metering, verification, or enforcement activities take place. At block 602, a command may be received and evaluated. At block 604, if the command is to set to the non-meter state, the ‘yes’ branch from block 604 may be taken to point “C” of FIG. 4. When the command is not a valid command to set the non-meter state, the ‘no’ branch from block 604 may be taken to block 606. In some embodiments, block 604 may not be implemented, effectively eliminating the opportunity to leave the non-enforcement state. Embodiments with and without block 604 each have certain advantages, as discussed above, but include limiting denial of service attacks on one hand and the opportunity to “trade up” and resell a paid up computer on the other hand. One, at block 604, the command is not a valid non-meter state command, execution may continue by following the ‘no’ branch from block 604 to block 606. At block 606, the command may be evaluated to determine whether it is a valid query. If so, the ‘yes’ branch from block 606 may be taken to block 610, and an inactive response may be returned to the calling party. If, at block 606, the command is not a valid query command, and ‘no’ branch from block 606 may be taken to block 608. At block 608, operation remains in the non-enforcement state and may wait at block 602 for the receipt of a new command.

As discussed above, each operating state may contain additional commands, such as firmware update commands for use in system maintenance and other normal activities. In other embodiments, additional states may be available for use, for example in one embodiment, a state may exist between the non-metered state and the active state to allow an incoming inspection test to be performed in a multi-tier distribution environment.

By creating the ability to operate a pay-per-use computer in different operating states, each having separate rules governing metering behavior, manufacturers, underwriters, and end-users may each realize specific benefits. Manufacturing operations are not hindered by metering, verification, and enforcement policies while an electronic device is in their control. Underwriters, that is, business entities who distribute computers or other electronic devices at less than market value in exchange for subscription service commitments, may rely on the computers build in security and enforcement mechanisms to enforce terms of a contract between themselves and an end-user. Lastly, the end-user has the opportunity to receive the benefit of un-metered use upon completion of the contractual terms of the subscription agreement.

Additionally, by allowing state transitions back up the chain of normal use, participants may realize additional benefits to remanufacture and reuse electronic devices, for example, when an end user wishes to trade up prior to the end of a subscription contract. In this example, an end-user has the opportunity to trade up, the underwriter has the opportunity to extend the relationship with the end-user and the manufacturer may be able to reuse a serviceable product at a minimal cost.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possible embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of managing lifecycle states of a metered-use electronic device having a security module adapted to enforce a metered-use state of operation and having operating states to accommodate manufacture, test, operation, and end-of-life, the method comprising:
setting the security module to a non-metered state at initial manufacture;
setting the security module to an active state after completion of manufacturing and before delivery to an end-user; and
setting the security module to a non-enforcement state responsive to a signal to disable metering.

2. The method of claim 1, further comprising setting the security module from the active state to the non-metered state responsive to a signal that indicates metering should be halted pending reconfiguration of the electronic device.

3. The method of claim 2, further comprising setting the security module from the non-metered state to the non-enforcement state responsive to a signal to permanently disable metering.

4. The method of claim 1, further comprising setting the security module from the active state to the active state following a post-manufacturing test, whereby setting the security module from the active state to the active state comprises restoring initial conditions for any attribute altered during the post-manufacturing test.

5. The method of claim 4, wherein setting the security module from the active state to the active state comprises setting the security module from the active state to the active state one time during the active state of the electronic device and before a first add-value transaction.

6. The method of claim 45 wherein setting the security module to the non-enforcement state comprises permanently disabling metering and any metering-related security enforcement.

7. The method of claim 1, further comprising metering the electronic device when in the active state.

8. The method of claim 1, wherein setting the security module to a non-enforcement state comprises setting the security module to a non-enforcement state wherein no metering takes place and all compliance-oriented security devices are rendered inoperative.

9. The method of claim 1, wherein setting the security module to an active state comprises setting configuration data including an initial usage balance, a reseller code, a program code, and a locale of operation.

10. The method of claim 1, further comprising operating the metered-use electronic device in the non-metered state whereby no metering is enforced and configuration messages and status messages are accepted.

11. The method of claim 1, further comprising operating the metered-use electronic device in the active state whereby metering and tampering security are enforced following the first boot after receiving a message to change from the non-metered state to the active state and whereby messages for state changes and status are accepted.

12. The method of claim 1, further comprising operating the metered-use electronic device in the non-enforcement state whereby metering and security enforcement are disabled and only status messages are accepted.

13. A security module for use in a metered-use electronic device comprising:
a communication port for at least receiving communication from a controller;
a processor coupled to the communication port; and
a memory coupled to the processor storing operating states and executable code implementing a state machine, the operating states comprising:
a non-metered state for use during manufacturing;
an active state used to enforce metered operation; and
a non-enforcement state for use when metering and security enforcement are permanently disabled.

14. The security module of claim 9, further comprising a cryptographic engine for decoding and verifying messages received via the communication port directing a change in operating state.

15. The security module of claim 9, wherein the executable code implementing the state machine comprises code for a transition from the active state to the non-enforcement state responsive to a request for the transition received via the communication port.

16. The security module of claim 9, wherein the memory is a tamper-resistant memory.

17. A method of operating an electronic device configured for metered operation, the electronic device comprising a security module for enforcing operating states, the method comprising:
operating in a non-metered state during an initial manufacturing phase;
operating in an active state following the initial manufacturing phase; and
operating in a non-enforcement state after receipt of a message to permanently cease metering and security enforcement.

18. The method of claim 17, further comprising setting initial operating conditions including metered-usage balance and an offer code when setting operation to the active state.

19. The method of claim 18, further comprising changing from the active state to the active state following a post-manufacturing test whereby initial operating conditions are reset.

20. The method of claim 17, further comprising disabling further state changes when entering the non-enforcement state.
